(19) United States
(12) Patent Application Publication
(10) Pub. No.: US 2018/0033386 A1
(43) Pub. Date: Feb. 1, 2018

(54) ELECTRO-OPTICAL DEVICE AND ELECTRONIC APPARATUS

(71) Applicant: SEIKO EPSON CORPORATION, Tokyo (JP)

(72) Inventors: Shinta ENAMI, Matsumoto-shi (JP); Katsutoshi UENO, Chino-shi (JP)

(73) Assignee: SEIKO EPSON CORPORATION, Tokyo (JP)

(21) Appl. No.: 15/640,844

(22) Filed: Jul. 3, 2017

(30) Foreign Application Priority Data
Jul. 26, 2016 (JP) 2016-146308

(51) Int. Cl. G09G 3/36; G02F 1/1345; G02F 1/1362

(52) U.S. Cl. CPC G09G 3/3648; G02F 1/136286; G02F 1/13452; G02F 2001/13629; G09G 2310/08

(57) ABSTRACT

An electro-optical device includes a substrate where a pixel area having a first pixel group and a second pixel group is provided, a first terminal group that is arranged in a peripheral portion of the substrate and in which a first terminal to which a video signal corresponding to the first pixel group is supplied is arranged in a first direction, a second terminal group that is arranged in the peripheral portion of the substrate and in which a second terminal to which a video signal corresponding to the second pixel group is supplied is arranged in the first direction, in which the length of the pixel area in the first direction is smaller than the combined length of the length of the first terminal group in the first direction and the length of the second terminal group in the first direction.

### BACKGROUND

### 1. Technical Field

The present invention relates to an electro-optical device and an electronic apparatus.

### 2. Related Art

In an electro-optical device, such as a liquid crystal panel, there is a problem that the number of terminals necessary for packaging increases as well as high definition increases. On the other hand, in JP-A-2009-194058, a technique of arranging electrode pad portions in a zigzag manner is disclosed.

In addition, in JP-A-2006-285058 a technique of vertical disposing a power supply terminal and a signal terminal in a pixel area.

In the technique described in JP-A-2009-194058, there is a problem that an electrode pad portion corresponding to the number of columns of pixels is necessary. Further, in the technique described in JP-A-2006-285058, there is a problem that if the pixel is made to have high definition, signal terminal spacing becomes narrow and it becomes difficult to package, or an area where terminals are arranged is enlarged, making downsizing difficult.

### SUMMARY

An advantage of some aspects of the present invention is to provide a technique capable of downsizing an electro-optical device with high definition by suppressing the difficulty of packaging.

According to an aspect of the invention, there is provided an electro-optical device which includes a substrate on which a pixel area having a first pixel group and a second pixel group is provided, a first terminal group that is arranged in a peripheral portion of the substrate and in which a first terminal to which a video signal corresponding to the first pixel group is supplied is arranged in a first direction, a second terminal group that is arranged in the peripheral portion of the substrate and in which a second terminal to which a video signal corresponding to the second pixel group is supplied is arranged in the first direction, in which the length of the pixel area in the first direction is smaller than the combined length of the length of the first terminal group in the first direction and the length of the second terminal group in the first direction.

In the aspect of the electro-optical device described above, the electro-optical device may further include a selection circuit that selects a pixel to which a video signal is to be respectively supplied from the first pixel group and the second pixel group.

In the aspect of the electro-optical device described above, the first pixel group and the second pixel group may be alternately arranged in the pixel area in the first direction.

In the aspect of the electro-optical device described above, the first terminal and the second terminal may have the same position in the first direction.

In the aspect of the electro-optical device described above, the electro-optical device may further includes a first wiring substrate that is connected to the first terminal group and a second wiring substrate that is connected to the second terminal group.

In the aspect of the electro-optical device described above, the first wiring substrate may be provided with a first drive circuit which supplies video signals to the first pixel group, and the second wiring substrate may be provided with a second drive circuit which supplies video signals to the second pixel group.

In the aspect of the electro-optical device described above, the first wiring substrate and the second wiring substrate may have the same function and shape.

In the aspect of the electro-optical device described above, the first wiring substrate and the second wiring substrate may be provided on one side of the substrate.

In the aspect of the electro-optical device described above, the first wiring substrate may be provided on a first side of the substrate, and the second wiring substrate may be provided on a second side opposite to the first side.

According to the aspect, it is possible to realize the electro-optical device which is compact and easy to achieve high definition.

According to another aspect of the invention, there is provided an electro-optical device including a substrate, a plurality of pixels that are provided on the substrate and have a first pixel group and a second pixel group arranged in a first direction with respect to the first pixel group, a first terminal that is formed on the substrate, a second terminal that is formed on the substrate and arranged in a second direction intersecting the first direction with respect to the first terminal, and a selection circuit that selects a pixel to which a video signal is to be respectively supplied from the first pixel group and the second pixel group.

According to the electro-optical device, it is possible to widen the terminal interval as compared with the case where the first terminal and the second terminal are arranged in a first direction.

In addition, the arrangement position of the first terminal and the second terminal in the first direction may be the same.

The first pixel group and the second pixel group may be respectively arranged by k columns in the first direction (k is an integer of 2 or more), and the selection circuit may select a pixel group in one column from the pixel group in the k columns for each of the first pixel group and the second pixel group.

According to the electro-optical device, in a case where the first terminal and the second terminal are driven by different drive circuits, it is possible to reduce display unevenness due to characteristic variation of the drive circuits.

The first pixel group and the second pixel group may be arranged in a total of k columns by being alternately arranged by one column in the first direction, and the selection circuit may select a pixel group in one column from the pixel group in the k columns for each of the first pixel group and the second pixel group.

According to the electro-optical device, in a case where the first terminal and the second terminal are driven by different drive circuits, it is possible to reduce display unevenness due to characteristic variation of the drive circuits.

The selection circuit may include a first wiring layer having a wiring for supplying video signals to the first pixel group and a second wiring layer having a wiring for supplying video signals to the second pixel group, that is different from the first wiring layer.

According to the electro-optical device, it is possible to drive the first pixel group and the second pixel group by different drive circuits.

In addition, the electro-optical device may further include the first wiring substrate that is connected the first terminal and the second wiring substrate that is connected to the second terminal.

Further, the first wiring substrate may be provided with a first drive circuit which supplies video signals to the first pixel group, and the second wiring substrate may be provided with a second drive circuit which supplies video signals to the second pixel group.

In addition, the first wiring substrate and the second wiring substrate may have the same function and may have the same shape.

In addition, the first wiring substrate and the second wiring substrate may be provided on one side of the substrate.

Further, the first wiring substrate may be provided on a first side of the substrate, and the second wiring substrate may be provided on a second side opposite to the first side.

In addition, according to still another aspect of the invention, there is provided an electronic apparatus including one of the electro-optical devices described above.

According to the electronic apparatus, it is possible to widen the terminal interval as compared with the case where the first terminal and the second terminal are arranged in a second direction.

### BRIEF DESCRIPTION OF THE DRAWINGS

The invention will be described with reference to the accompanying drawings, wherein like numbers reference like elements.

FIG. 1 is a perspective diagram showing a configuration of an electro-optical device according to one embodiment.

FIG. 2 is a schematic diagram showing a configuration of the electro-optical device.

FIG. 3 is a diagram showing an arrangement of terminal groups on an element substrate.

FIG. 4 is a diagram showing an arrangement relationship between a video signal input terminal and pixels.

FIGS. 5A and 5B are diagrams showing a configuration of an electro-optical panel according to a comparative example.

FIG. 6 is a diagram showing an equivalent circuit of pixels and a data line selection circuit.

FIG. 7 is a timing chart showing an example of the operation of an electro-optical device.

FIG. 8 is a diagram showing a projector according to one embodiment.

FIG. 9 is a diagram showing another example of a positional relationship between a video signal input terminal and pixels.

FIG. 10 is a timing chart showing an example of the operation of an electro-optical device according to an example in FIG. 9.

### DESCRIPTION OF EXEMPLARY EMBODIMENTS

### 1. Structure

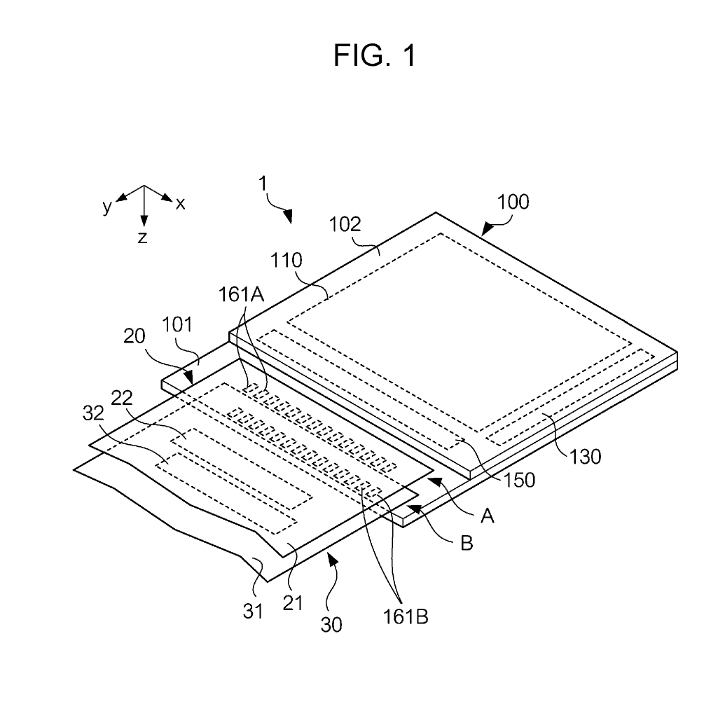

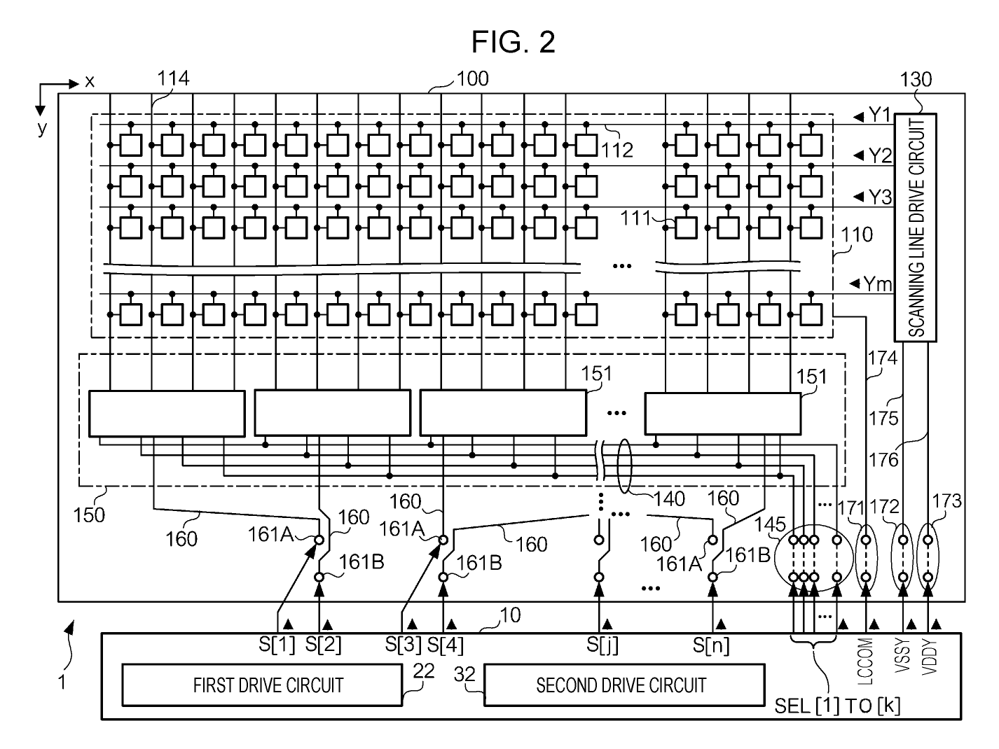

FIG. 1 is a perspective diagram showing a configuration of the electro-optical device 1 according to one embodiment, and FIG. 2 is a schematic diagram showing a configuration of the electro-optical device 1. The electro-optical device 1 includes an electro-optical panel 100, a first wiring substrate 20, and a second wiring substrate 30. The electro-optical device 1 is a device used for displaying an image, and used as a light valve of a projector as one example.

The electro-optical panel 100 changes the optical state thereof according to a given signal, that is, forms an image. In this example, the electro-optical panel 100 is a transparent liquid crystal panel. The electro-optical panel 100 includes an element substrate 101, an opposing substrate 102, and a liquid crystal (not shown in the diagram). The element substrate 101 and the opposing substrate 102 are stuck together with a gap therebetween. The liquid cry al is sealed in this gap and forms a liquid crystal layer. The liquid crystal is, for example, a Vertical Alignment (VA) type liquid crystal. The element substrate 101 (an example of the first substrate) is a substrate where a pixel electrode (not shown in the diagram) and a circuit element (a transistor, or the like, not shown in the diagram) for writing a voltage to the pixel electrode thereof are formed. The opposing substrate 102 (an example of the second substrate) is a substrate where a common electrode (not shown in the diagram) is formed. Both the element substrate 101 and the opposing substrate 102 are formed of a light-transmitting material such as glass or quartz.

The first wiring substrate 20 and the second wiring substrate 30 are for connecting the electro-optical panel 100 to another device such as a circuit board. The first wiring substrate 20 includes a wiring formed on a Flexible Printed Circuit (FPC) substrate 21 and a first drive circuit 22. The second wiring substrate 30 includes a wiring formed on an FPC substrate 31 and a second drive circuit 32. The first wiring substrate 20 and the second wiring substrate 30 are a so-called Chip On Film (COF). The first wiring substrate 20 includes a connection area (not shown) for connecting with a terminal group A including a video signal input terminal 161A and the like of the electro-optical panel 100. The second wiring substrate 30 includes a connection area (not shown) for connecting with a terminal group B including a video signal input terminal 161B and the like of the electro-optical panel 100. Due to the terminal groups and the connection areas, the electro-optical panel 100 is electrically connected to the first wiring substrate 20 and the second wiring substrate 30.

The electro-optical panel 100 includes a pixel area 110, a scanning line drive circuit 130, a data line selection circuit 150, n pieces of video signal lines 160, n pieces of video signal input terminals 161, k pieces of selection signal lines 140, k pieces of selection signal input terminals 145, a plurality of power supply terminals 171, 172, and 173, and power lines 174, 175, and 176 corresponding thereto. n is an integer of 1 or more, and k is an integer of 2 or more. In the example of FIG. 2, k=4. These elements are formed on the element substrate 101. The data line selection circuit 150 is formed along one side of a peripheral portion of the pixel area 110 of the element substrate 101, and the scanning line drive circuit 130 is formed along another side that intersects the side where the data line selection circuit 150 is formed. The terminal groups A and B are formed on the side opposite to the pixel area 110, that is, on the end side of the substrate with respect to the data line selection circuit 150.

In this example, a drive circuit 10 including the first drive circuit 22 and the second drive circuit 32 is used to drive a large number of pixels of high definition display at high speed. The first drive circuit 22 and the second drive circuit 32 output the video signal indicating the image to be displayed on the electro-optical panel 100 according to a clock signal, a control signal, and a video signal input from an external upper circuit. The electro-optical panel 100 displays the image according to the clock signal and the video signal input from the first drive circuit 22 and the second drive circuit 32, and other circuits. In this example, the first drive circuit 22 and the second drive circuit 32 are a drive circuit with the same function, and it is possible to output the same signal except a data signal.

The pixel area 110 is an area for displaying an image. The pixel area 110 includes m pieces of scanning lines 112, (k×n) pieces of data lines 114, and (m×k×n) pieces of pixels 111. m is an integer of 1 or more. The pixels 111 are provided corresponding to the intersection of the scanning line 112 and the data line 114 and arranged in a matrix of m rows×(k×n) columns. The scanning line 112 is a signal line transmitting a scanning signal and is provided along the row direction (x direction) from the scanning line drive circuit 130. The data line 114 is a signal line for transmitting a data signal and is provided in the column direction (y direction) from the data line selection circuit 150. The scanning line 112 and the data line 114 are electrically insulated. In addition, in this example, k×m pieces of pixels 111 corresponding to k pieces (columns) of data lines 114 form one a pixel group (block). Considering the pixels 111 in one column as one sub-pixel group, one pixel group is formed of k pieces (columns) of sub-pixel groups. The pixels 111 belonging to a pixel group are connected to the same video signal line 160 via the data line selection circuit 150. That is, the electro-optical panel 100 includes n pieces (columns) of pixel groups divided into n pieces of blocks by n pieces (columns) of video signal lines 160 or n pieces of video signal input terminals 161. The details of the pixels 111 will be described later. In the following description, when it is necessary to distinguish each of the plurality of the scanning lines 112, each scanning line is expressed as the scanning line 112 in the first row, the second row, the third row, . . . , and the m-th row. When it is necessary to distinguish each of the plurality of the data lines 114, each date line is expressed as the data line 114 in the first column, the second column, the third column, . . . , and the (k×n)th column. The same applies to the video signal line 160. In addition, in this example, the k pieces of sub-pixel groups forming one pixel group or the corresponding k pieces of data lines 114 are sequentially arranged in the row direction, but the sub-pixel groups or the data lines are not necessarily sequentially arranged. In this example, since the k pieces of data lines 114 are continuous in the row direction, it is possible to prevent the video signal lines 160 from intersecting with each other, or the video signal line 160 from intersecting with a wiring affecting a data signal.

The scanning line drive circuit 130 selects a row to write data out of a plurality of the pixels 111 arranged in a matrix. Specifically, the scanning line drive circuit 130 outputs a scanning signal for selecting one scanning line 112 from the plurality of the scanning lines 112. The scanning line drive circuit 130 supplies the scanning signals Y1, Y2, Y3, . . . , and Ym to the scanning line 112 in the first row, the second row, the third row, . . . , and the m-th row. In this example, the scanning signals Y1, Y2, Y3, . . . , and Ym are signals which are of an exclusively sequential at high level.

The data line selection circuit 150 selects the columns of the pixels 111 in which data is written in each pixel group. Specifically, the data line selection circuit 150 selects at least one data line 114 from the k pieces of data lines 114 belonging to the pixel group according to selection signals SEL[1] to SEL[k]. The data lines 114 are connected to the video signal lines 160, one by one, in units of k pieces of data lines by the data line selection circuit 150. The data line selection circuit 150 includes n pieces of demultiplexers 151 corresponding to each of the n pixel groups. The details of the demultiplexer 151 will be described later.

The video signal line 160 connects between a video signal input terminal 161 and the data line selection circuit 150. The video signal line 160 is a signal line that transmits video signals S (S[1] to S[n]) input from the first wiring substrate 20 and the second wiring substrate 30 via the video signal input terminal 161 to the data line selection circuit 150, and n columns (pieces) of signal lines are provided corresponding to each of the n pieces of video signal input terminals 161 or n pieces of pixel groups. The video signals S are signals indicating data written in the pixels 111. Here, “video” means a still image car a moving image. One video signal line 160 is connected to k pieces of data lines 114 via the data line selection circuit 150. Therefore, in the video signals S, the data supplied to k pieces of data lines 114 are time-division multiplexed.

The selection signal line 140 connects between the selection signal input terminal 145 and the demultiplexer 151 of the data line selection circuit 150. The selection signal lines 140 (140[1] to 140[k]) are signal lines that transmit the selection signals SEL (SEL[1] to SEL[k]) input from the selection signal input terminals 145 (145[1] to 145[k]), and k pieces of signal lines are provided. The selection signal SEL is a signal which sequentially becomes a signal with a high level.

The video signal input terminal 161 is a terminal (electrode pad) connected to the first wiring substrate 20 and the second wiring substrate 30, and the video signal S[j] is supplied (j is an integer satisfying 1≦j≦n). In this example, the video signals S[1], S[3], S[5], and S[2t−1] are supplied to the video signal input terminal 161 corresponding to the video signal lines 160 in odd columns such as the first column, the third column, the fifth column, . . . , and the (2t−1)th column from the first drive circuit 22 of the first wiring substrate 20 (t is an integer satisfying 1≦t≦n/2). In addition, the video signals S[2], S[4], S[6], and S[2t] are supplied to the video signal input terminal 161 corresponding to the video signal lines 160 in even columns such as the second column, the fourth column, the sixth column, . . . , and the (2t)th column from the second drive circuit 32 of the second wiring substrate 30. The video signal S is a so-called data signal, and in this example, signals having different waveforms according to the display of the image are supplied to the video signal input terminals 161 corresponding to the terminal groups A and B, respectively. For example, the video signal S is an analog signal.

A selection signal input terminal 145 is a terminal (electrode pad) connected to the first wiring substrate 20 and the second wiring substrate 30, and the selection signal SEL is supplied. The selection signal SEL is supplied from both or one of the first drive circuit 22 of the first wiring substrate 20 and the second drive circuit 32 of the second wiring substrate 30. The selection signal SEL is a timing signal for selecting the data line 114 in the data line selection circuit 150, and in this example, selection signals SEL having the same waveform are supplied to the selection signal input terminals 145 corresponding to the terminal groups A and B, respectively. For example, the selection signal SEL is a pulse signal.

The power supply terminal 171, the power supply terminal 172, and the power supply terminal 173 are terminals (electrode pads) connected to the first wiring substrate 20 and the second wiring substrate 30, and a source voltage is supplied. The source voltage is a voltage used as a power source in the electro-optical panel 100, and is a DC voltage in this example. The power supply terminal 171 is a terminal for supplying a voltage LCCOM, the power supply terminal 172 is a terminal for supplying a voltage VSSY, and the power supply terminal 173 is a terminal for supplying a voltage VDDY. The voltage LCCOM is a voltage which is a reference potential of a voltage applied to the liquid crystal layer. The voltage VSSY is a voltage which is the power supply potential on the low voltage side in the scanning line drive circuit 130. The voltage VDDY is a voltage which is the power supply potential on the high voltage side in the scanning line drive circuit 130.

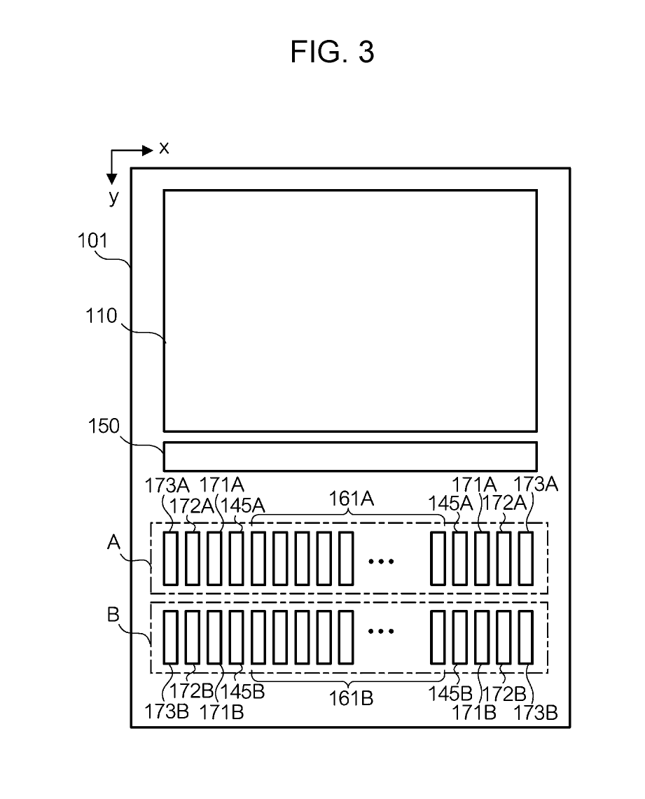

FIG. 3 is a diagram showing the arrangement relationship of the terminal groups A and B in the element substrate 101. As described in FIGS. 1 and 2, the terminal groups A and B are arranged on one side of the peripheral area of the element substrate 101. The terminal group A is the terminal group connected to the first wiring substrate 20, and the terminal group B is the terminal group connected to the second wiring substrate 30. The terminal groups A and B include a plurality of the video signal input terminals 161, a plurality of the selection signal input terminals 145, a plurality of the power supply terminals 171 to 173, and the like. The terminal group B is arranged in the longitudinal direction (column direction) of the element substrate 101 with respect to the terminal group A. In this example, the terminal group B is formed on the side opposite to the pixel area 110 with respect to the terminal group A, that is, on the end side of the substrate.

The terminal group A includes the video signal input terminal 161A, the selection signal input terminal 145A, the power supply terminals 171A to 173A, and each terminal is arranged in a row along the lateral direction (row direction) of the element substrate 101. The terminal group B includes the video signal input terminal 161B, the selection signal input terminal 145B, the power supply terminals 171B to 173B, and each terminal is arranged in a row along the lateral direction of the element substrate 101. The video signal input terminal 161B, the selection signal input terminal 145B, and the power supply terminals 171B to 173B have the same position in the lateral direction and are arranged in the longitudinal direction, respectively, with respect to the video signal input terminal 161A, the selection signal input terminal 145A, and the power supply terminals 171A to 173A, respectively. In addition, in this example, each terminal having the same position in the lateral direction of the terminal group A and the terminal group B is a terminal to which the same type of signal is input, and the shape of the terminal is also the same.

In addition, the number of the video signal input terminals 161A and the video signal input terminals 161B that are arranged is at least n in total. In this example, the number of the video signal input terminals 161A and the video signal input terminals 161B are the same number, and n/2 pieces of terminals are arranged in the middle of the lateral direction of the terminal group.

k pieces of selection signal input terminals 145A and selection signal input terminals 145B are respectively arranged on both sides of the video signal input terminal 161A and the video signal input terminal 161B (in FIG. 3, only one piece is shown on each side). The selection signal input terminal 145A and the selection signal input terminal 145B are provided on both sides, respectively, and therefore it is possible to input the selection signal SEL from both ends of the selection signal line 140. In addition, by providing the selection signal input terminal 145A and the selection signal input terminal 145B, it is possible to input the selection-signal SEL from both or one of the first wiring substrate 20 and the second wiring substrate 30. In addition, as the example in FIG. 2, k pieces of selection signal input terminal 145 may be provided on only one side of the video signal input terminals 161, and the selection signal SEL may be input from one end of the selection signal line 140.

The power supply terminals 171A to 173A and the power supply terminals 171B to 173B are provided on both ides of the video signal input terminal 161A and the video signal input terminal 161B, respectively. This is because, for example, the scanning line drive circuit 130 corresponds to a configuration in which one scanning line drive circuit 130 is provided on each of the left and right sides of the substrate 101. As the example in FIG. 2, in the configuration in which only one scanning line drive circuit 130 is used, the selection signal input terminal 145 and the power supply terminals 171 to 173 may be provided on only one side of the video signal input terminal 161.

Also in FIG. 3, the longitudinal direction is the column direction in which the data line 114 extends in the pixel area 110, that is, the y direction. In addition, the lateral direction is the row direction in which the scanning line 112 extends in the pixel area 110, that is, the x direction. The lateral direction is an example of a first direction, and the longitudinal direction is an example of a second direction. In addition, the first and second directions are the longitudinal direction and the lateral direction with respect to the display of the image of a liquid crystal panel 100, respectively.

The terminal group A is an example of the first terminal group, which in this example is the terminal group for connecting to the first wiring substrate 20, and the video signal input terminal 161A, the selection signal input terminal 145A, and the power supply terminals 171A to 173A are arranged in a row along the lateral direction. The power supply terminal 171A, the power supply terminal 172A, and the power supply terminal 173A are examples of a first power supply terminal, a third power supply terminal, and a fourth power supply terminal, respectively. The terminal group B is an example of the second terminal group, which in this example is the terminal group for connecting to the second wiring substrate 30, and the video signal input terminal 161B, the selection signal input terminal 145B, and the power supply terminals 171B to 173B are arranged in a row corresponding to the terminal group A along the lateral direction. The power supply terminal 171B, the power supply terminal 172B, and the power supply terminal 173B are examples of a second power supply terminal, a fifth power supply terminal, and a sixth power supply terminal, respectively.

In the electro-optical panel 100, the terminal group B is arranged in the longitudinal direction (different position in the y direction) with respect to the terminal group A. By providing the two terminal groups of the terminal croup A and the terminal group B, the two terminal groups can be connected to different wiring substrates (in this example, the first wiring substrate 20 and the second wiring substrate 30), respectively, and it is possible to drive each terminal group with a different drive circuit (the first drive circuit 22 and a second drive circuit 32 in this example).

Further, since the terminal group A and the terminal group B are arranged in the longitudinal direction, as compared with the case where the terminal group A and the terminal group B are arranged in the lateral direction, it is possible to arrange the spacing between the terminals in the lateral direction in a crude manner (widely), or increase the size of each terminal in the lateral direction.

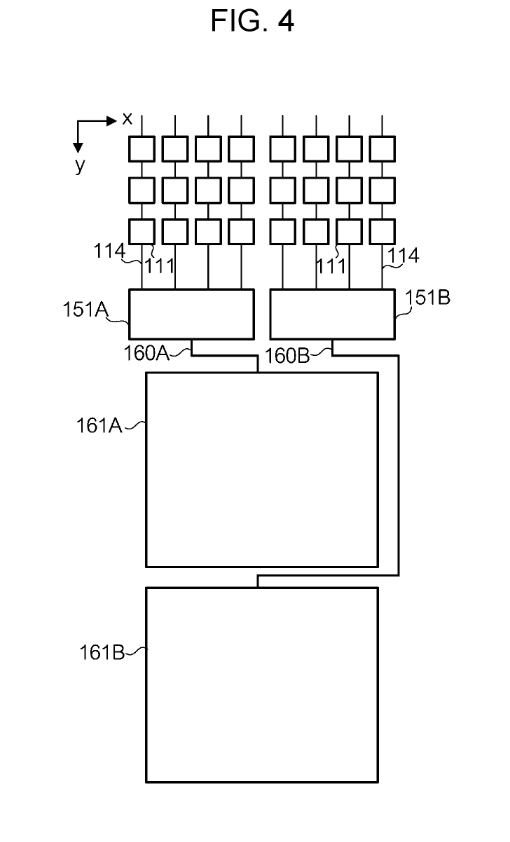

FIG. 4 is a diagram showing the connection relationship between the video signal input terminal 161 and the pixels 111. In FIG. 4, among n pieces of pixel groups and n pieces of video signal input terminals 161 shown in the example of FIG. 2, only two consecutive pixel groups and the two video signal input terminals 161 corresponding thereto are shown. In addition, the video signal lines 160 and the demultiplexers 151 corresponding to the two consecutive pixel groups are also shown. In this example, the video signal input terminals 161 are divided into two groups of terminals including the terminals connected to an odd numbered (odd numbered columns) pixel group (block) and the terminals connected to an even numbered (even numbered columns) pixel group (block). Here, the terminals corresponding to the odd numbered pixel group are the video signal input terminals 161A of the terminal group A, and the terminals corresponding to the even numbered pixel group are the video signal input terminals 161B of the terminal group B. A demultiplexer 151A is the demultiplexer 151 corresponding to the odd numbered pixel group and a demultiplexer 151B is the demultiplexer 151 corresponding to the even numbered pixel group. The video signal input terminals 161A are connected to the data lines 114 of the odd numbered pixel group via the odd numbered video signal lines 160 and the demultiplexer 151A. In addition, the video signal input terminals 161B are connected to the data lines 114 of the even numbered pixel group via the even numbered video signal lines 160 and the demultiplexer 151B. The video signal input terminals 161A and the video signal input terminal 161B are different not only in the connected demultiplexer 151 but also in the wiring substrates (drive circuits) to which the video signal is supplied. In this example, the video signal input terminals 161A and the video signal input terminals 161B are connected to the first wiring substrate 20 and the second wiring substrate 30, respectively, and a video signal is supplied from the first drive circuit 22 and the second drive circuit 32. That is, the video signal input terminals 161, in the first row which is the terminal group A receive video signals S1, S3, S5, . . . , and S(2t−1) corresponding to the odd numbered pixel group from the first drive circuit 22. In addition, the video signal input terminals 161B in the second row which is the terminal group B receive video signals S2, S4, S6, . . . , and S(2t−1) corresponding to the even numbered pixel group from the second drive circuit 32. The video signal input terminals 161A of the terminal group A are an example of first video signal input terminals and the video signal input terminals 161B of the terminal group B are an example of second video signal input terminals.

The pixel group connected to the video signal input terminals 161A of the terminal group A is an example of the first pixel group, and the pixel group connected to the video signal input terminals 161B of the terminal group B is an example of the second pixel group. In this example, the first pixel group and the second pixel group are arranged by n/2 pieces in the lateral direction, respectively. Since each the pixel group is provided with k pieces of consecutive data lines 114, the data lines 114 are alternately connected to the video signal input terminals 161A and the video signal input terminals 161B in units of k pieces of consecutive data lines. In addition, the demultiplexer 151 selects a sub-pixel group in one column from the sub-pixel groups in the k columns for each of the first pixel group and the second pixel group. In this example, since k pieces of data lines 114 are consecutive in the row direction, the demultiplexer 151 can be arranged in the row direction (x direction) corresponding to each pixel group, and therefore it is possible to prevent the video signal line 160 from intersecting with each other or the video signal line 160 from intersecting with a wiring affecting a data signal.

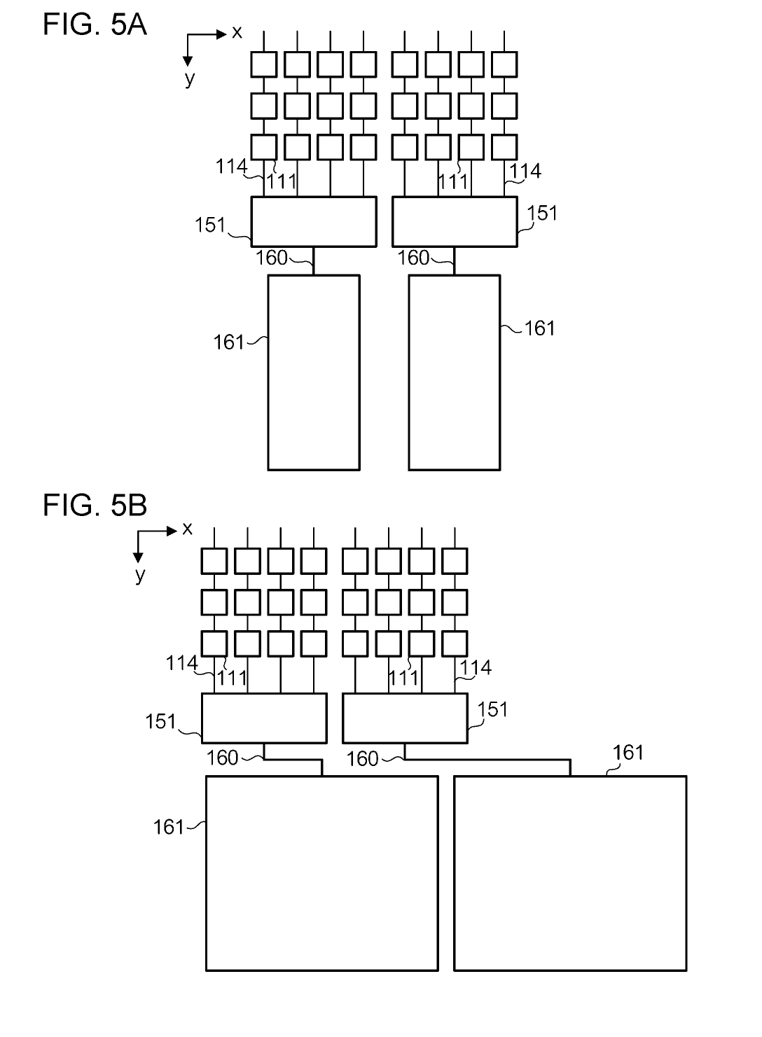

In addition, in this example, one video signal input terminal 161 is connected to four pieces (k=4) of data lines 114 via the data line selection circuit 150. As an example, an example in which four pieces of data lines 114 sequentially arranged in the lateral direction (row direction) with the spacing between the data lines 114 in the pixel area 110 (for example, the distance between the centers of two data lines) set to 6 μm form a block is considered. In the high-definition electro-optical panel 100, the ratio of the video signal input terminal 161 to the size of the arrangement area of the terminal group increases. In the comparative example of FIGS. 5A and 5B in which the video signal input terminal 161 is arranged in one row in the lateral direction, in a case where the size (width) of the arrangement area in the lateral direction (approximately, arrangement area of the terminal group) of the pixel area 110 and the video signal input terminal 161 is set to be approximately the same, the spacing between the adjacent video signal input terminals 161 (distance between the centers of the terminals) is 24 μm (4×6 μm) (FIG. 5A). This means that the size of the electrode pad forming the terminals must be less than 24 μm in order to make the size of the arrangement area of the terminal group and the size of the pixel area 110 almost equal, and advanced ability of packaging wiring substrates and electro-optical panels is required, which is not easy. In addition, in a case where the size of the electrode pad is 48 [μm], the size of the terminal group in the lateral direction is at least n×48 [μm], which is about twice as large as n×24 [μm] (n×4×6 [μm]) corresponding to the size of the pixel area 110 in the lateral direction, and the miniaturization of the electro-optical panel 100 cannot be achieved (FIG. 5B). However, in an example in which the video signal input terminals 161A and the video signal input terminals 161B are arranged in two rows in the longitudinal direction as in the present embodiment, the spacing between the adjacent video signal input terminals 161A can be 48 [μm], and the width that can be used as one electrode pad is increased to about twice that of the comparative example, which makes packaging easier. In addition, even if the size of the electrode pad is about 48 [μm], the size of the arrangement area of the video signal input terminal 161 in the lateral direction is n×24 [μm] (n/2×48 [μm]), which is equivalent to n×24 [μm] (n×4×6 [μm]) corresponding to the size of the pixel area 110 in the lateral direction.

If the spacing (pitch) between the data lines 114 is set to d [μm], the spacing (pitch) between the electrode pads of the video signal input terminals 161 is set to p [μm], the number of the terminal groups arranged in the longitudinal direction, that is the number of wiring substrates to which the terminal groups are connected is set to c [pieces], the size of the pixel area 110 in the lateral direction is at least k×n×d [μm], and the size in the lateral direction necessary for arranging the video signal input terminal 161 is at least n/c×p[μm]. (n/c×p<k×n×d) for reducing the size in the lateral direction required to arrange the video signal input terminal 161 in one column with respect tri the size of the pixel area 110 in the lateral direction, is effective for downsizing the electro-optical panel 100. That is, if c, p, k and d are determined so as to satisfy the relationship of p/c<k×d, it is possible to realize the electro-optical device 1 in the small size and high definition without depending largely on the capability of the drive circuit, ability of packaging wiring substrates and electro-optical panels, and the like. For example, if k=8, c=2, n=520, and d=6 [μm], the number of the data lines 114 is 4,160 (8×520 pieces), the electro-optical device 1 can be realized in a small size and high definition with the size of the pixel area 110 in the lateral direction being 24,960 [μm] (6×4160 [μm]). In this case, the size of one line of the arrangement area of the video signal input terminal 161 in the lateral direction is 260×p [μm] (520/2×p [μm]) and the spacing p between the electrode pads is 96 [[μm] (24,960/260 [μm]), which makes packaging easier. Further, in a case where the size (width) of the electrode pad is set to 56 [μm], the gap in the lateral direction between the electrode pads is 40 μm, a video signal line 160B of about 10 [μm] (for example, 8 to 12 [μm]) can be easily arranged between the video signal input terminals 161A, and routing of wirings from the terminal group arranged in the longitudinal direction becomes also easier.

By respectively connecting the two wiring substrates (the first wiring substrate 20, the second wiring substrate 30) respectively provided with the drive circuits (the first drive circuit 22, the second drive circuit 32) that are capable of outputting 260 video signals to the terminal groups A and B in two rows, it is easy to package the terminals and to drive 4,160 (8×2×260) pieces of data lines 114 corresponding to high definition display.

Further, in this example, the pixel group driven by the first drive circuit 22 and the pixel group driven by the second drive circuit 32 are alternately arranged. In other words, the data lines 114 are alternately arranged for every k pieces, one data lines connected to the first drive circuit 22 and the one other data lines connected to the second drive circuit 32. As a result, for example, as compared with a case where the left half of the entire data lines 114 is connected to the first drive circuit 22 and the right half thereof is connected to the second drive circuit 32, it is possible to suppress the display unevenness due to the variation in the characteristics of the drive circuit.

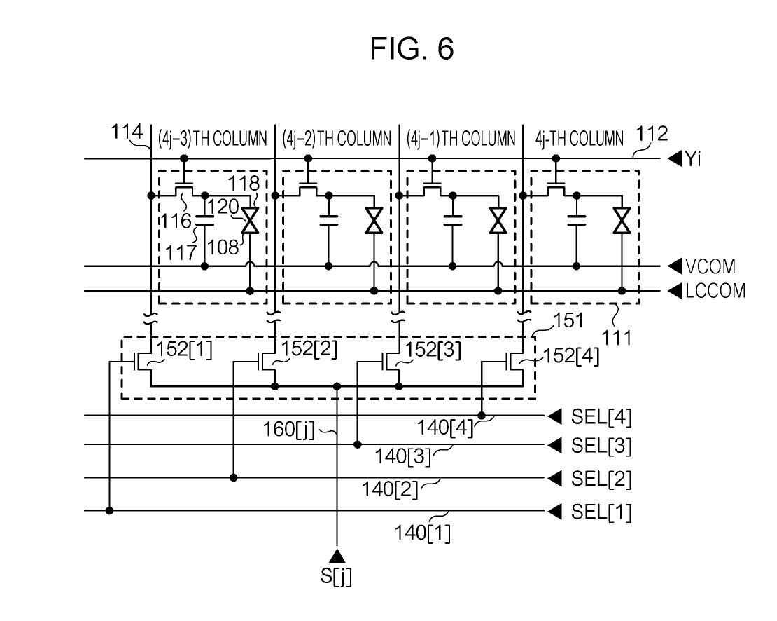

FIG. 6 is a diagram showing an equivalent circuit of the demultiplexer 151 of the pixels 111 and the data line selection circuit 150. In FIG. 6, the pixels 111 in the (k×j−k+1)th column to the (k×j)th column of the i-th row of the pixel area 110 and the demultiplexer 151 corresponding thereto are shown (i is an integer satisfying 1≦i≦m). In the i-th row, one block is form of k pieces (k=4 in this example) of consecutive pixels 111. The pixels 111 include a Thin Film Transistor (TFT) 116, a pixel electrode 118, a liquid crystal layer 120, a common electrode 108, and a retention volume 117. The TFT 116 is a switching element fob controlling writing (application of voltage) data to the pixel electrode 118, and in this example, is an n-channel type field effect transistor. The gate electrode of the TFT 116 is connected to the scanning line 112, the source electrode is connected to the data line 114, and the drain electrode is connected to the pixel electrode 118. When the scanning line 112 is supplied with a high level of scanning signal, the TFT 116 is turned on and the data line 114 and the pixel electrode 118 are brought into a low impedance state. That is, data is written in the pixel electrode 118. When the scanning line 112 is supplied with a low level of scanning signal, the TFT 116 is turned off and the data line 114 and the pixel electrode 118 are brought into a high impedance state. The common electrode 108 is common to all the pixels 111. The common voltage LCCOM is applied to the common electrode 108, for example, by the first drive circuit 22 and the second drive circuit 32. A voltage corresponding to the potential difference between the pixel electrode 118 and the common electrode 108 is applied to the liquid crystal layer 120, and an optical characteristic (transmittance or reflectance) is changed according the voltage. The retention volume 117 is connected in parallel with the liquid crystal layer 120 and holds electric charge corresponding to the potential difference between the pixel electrode 118 and the common voltage VCOM (in this example, VCOM=LCCOM). Hereinafter, when distinguishing each of the elements included in the pixels 111 in a particular pixel group, the elements are distinguished by TFT 116[s] (s is an integer satisfying 1≦s≦k).

The demultiplexer 151 is a circuit for supplying the video signal S to the data line 114 selected according to the selection signals SEL[1] to SEL[k]. The video signal input from the video signal input terminal 161 is supplied to the demultiplexer 151 via the video signal line 160. One demultiplexer 151 includes one video signal input unit, pieces of selection signal input units, k pieces of video signal output units, k pieces of TFTs 152 (152[1] to 152[k]), and one video signal input terminal 161 via the video signal line 160 and k pieces of selection signal input terminals 145 (145[1] to 145[k]) via the selection signal line 140 are connected with k pieces of data line 114. The TFT 152 is a switching element for selecting the data line 114 according to the selection signal SEL input to the gate.

The gate electrode of the TFT 152[1] is connected to the selection signal line 140[1], the source electrode is connected to the video signal line 160 in the j-th column, the drain electrode is connected to the data line 114 in the (4j−3)th column (that is, the source electrode of the TFT 116[1] in the j-th pixel group). When a high level of selection signal SEL[1] is supplied to the selection signal line 140[1], the TFT 152 is turned on, and the video signal line 160 in the j-th column and the data line 114 in the (4j−3)th column are brought into a low impedance state and become conductive. That is, the video signal S[j] is supplied to the data line 114 in the (4j−3)th column. When a low level of selection signal SEL[1] is supplied to the selection signal line 140[1], the TFT 152[1] is turned off, and the video signal line 160 in the j-th column and the data line 114 in the (4j−3) th column are brought into a high impedance state.

The gate electrode of the TFT 152[2] is connected to the selection signal line 140[2], the source electrode is connected to the video signal line 160 in the j-th column, the drain electrode is connected to the data line 114 in the (4j−2)th column (that is, the source electrode of the TFT 116[2] in the j-th pixel group). When a high level of selection signal SEL[2] is supplied to the selection signal line 140[2], the TFT 152[2] is turned on, and the video signal line 160 in the j-th column and the data line 114 in the (4j−2)th column become conductive. That is, the video signal S[j] is supplied to the data line 114 in the (4j−2)th column. When a low level of selection signal SEL[2] is supplied to the selection signal line 140[2], the TFT 152[2] is turned off, and the video signal line 160 in the j-th column and the data line 114 in the (4j−2)th column are brought into a high impedance state.

The gate electrode of the TFT 152[3] is connected to the selection signal line 140[3], the source electrode is connected to the video signal line 160 in the j-th column, the drain electrode is connected to the data line 114 in the (4j−1)th column (that is, the source electrode of the TFT 116[3] in the j-th pixel group). When a high level of selection signal SEL[3] is supplied to the selection signal line 140[3], the TFT 152[3] is turned on, and the video signal line 160 in the 1-th column and the data line 114 in the (4j−1)th column become conductive. That is, the video signal S[j] is supplied to the data line 114 in the (4j−1)th column. When a low level of selection signal SEL[3] is supplied to the selection signal line 140[3], the TFT 152[3] is turned off, and the video signal line 160 in the j-th column and the data line 114 in the (4j−1)th column are brought into a high impedance state.

The gate electrode of the TFT 152[4] is connected to the selection signal line 140[4], the source electrode is connected to the video signal line 160 in the j-th column, the drain electrode is connected to the data line 114 in the 4j-th column (that is, the source electrode of the TFT 116[4] in the pixel group in th j-th column). When a high level of selection signal SEL[4] is supplied to the selection signal line 140[4], the TFT 152[4] is turned on, and the video signal line 160 in the j-th column and the data line 114 in the 4j-th column become conductive. That is, the video signal S[j] is supplied to the data line 114 in the 4j-th column. When a low level of selection signal SEL[4] is supplied to the selection signal line 140[4], the TFT 152[4] is turned off, and the video signal line 160 in the 1-th column and the data line 114 in the 4j-th column are brought into a high impedance state.

### 2. Operation

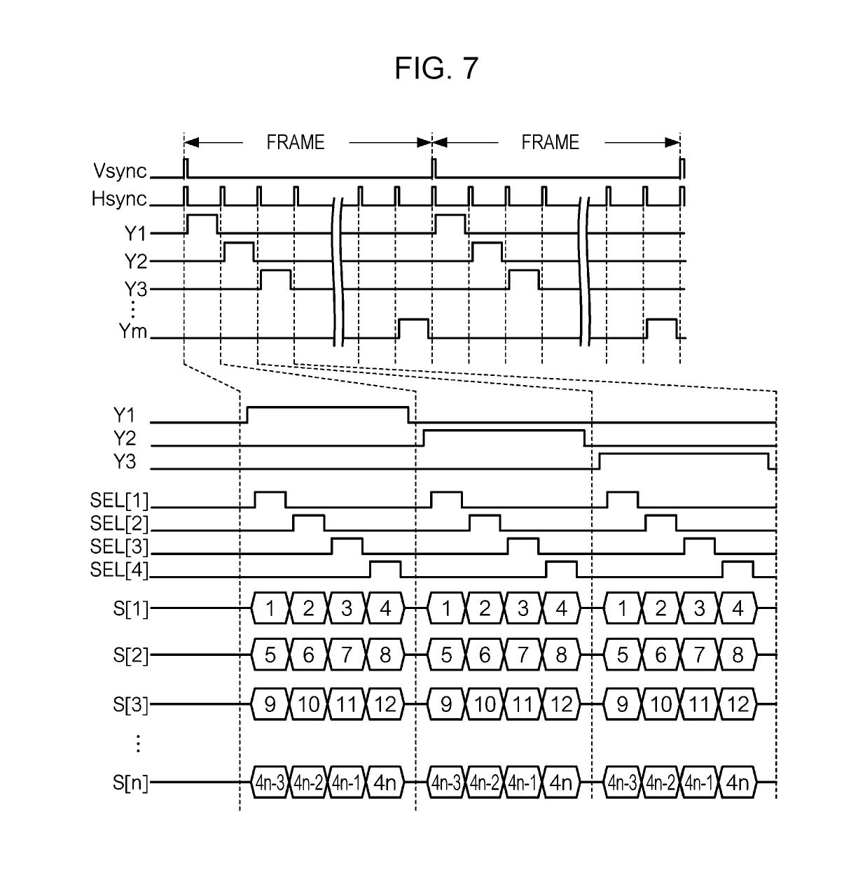

FIG. 7 is a timing chart showing an example of an operation of the electro-optical device 1. For the sake of description, a horizontal synchronization signal Hsync, the scanning signals Y1 to Y3, the selection signals SEL[1] to SEL[k] corresponding to the scanning signals Y1 to Y3 at high level timing, and the video signal S[1] to S[n] are shown. In the video signal S[j], the data written to the pixels 111 in the [k×j−k+1]th to the [k×j]th columns, which is the k pieces of pixels 111 in the corresponding pixel group, is time-division multiplexed. In addition, in this example, in a case where S[j] is S[2t−1], the video signal S is supplied from the first drive circuit 22 to the data lines 114 of the odd numbered pixel groups via the video signal input terminal 161A and the video signal line 160A. In a case where S[j] is S[2t], the video signal is supplied from the second drive circuit 32 to the data lines 114 of the even numbered pixel groups via the video signal input terminal 161B and the video signal line 160B. For example, the video signals S[1] and S[2] are the video signal S supplied to the video signal input terminal 161A and the video signal input terminal 161B, respectively. In this example, k=4, and the four data lines 114 are sequentially arranged in the lateral direction. In the video signal S1 to S(2t−1), the data to be written to the pixels 111 in the first, the second, the third, and the fourth column to the (8t−7)th, the (8t−6)th, the (8t−5)th, and the (8t−4)th column is time-division multiplexed, in the video signal S2 to S(2t), the data to be written to the pixels 111 in the fifth, the sixth, the seventh, and the eighth column to the (8t−3)th, the (8t−2)th, the (8t−1)th column, and the (8t)th column is time-division multiplexed. The number written in the waveforms of the video signal in the diagram shows the data lines 114 to which the signal thereof is supplied. For example, data in the period marked “1” in the video signal S1 is supplied to the data line 114 in the first column.

By using the two drive circuits of the first drive circuit 22 and the second drive circuit 32, it is possible to write data to the pixel which is twice as large in one period as compared with the case where these drive circuits are used alone. As described above, the first drive circuit 22 and the second drive circuit 32 are provided in different wiring substrates (the first wiring substrate 20 and the second wiring substrate 30), respectively. By arranging the video signal input terminal 161B to which the video signal supplied from the first drive circuit 22 is input and the video signal input terminal 161B to which the video signal supplied from the second drive circuit 32 is input, in the longitudinal direction, it is possible to achieve smaller size and higher definition as compared with the case where these are arranged in the lateral direction. In addition, high-speed driving becomes also easier.

### 3. Application Example

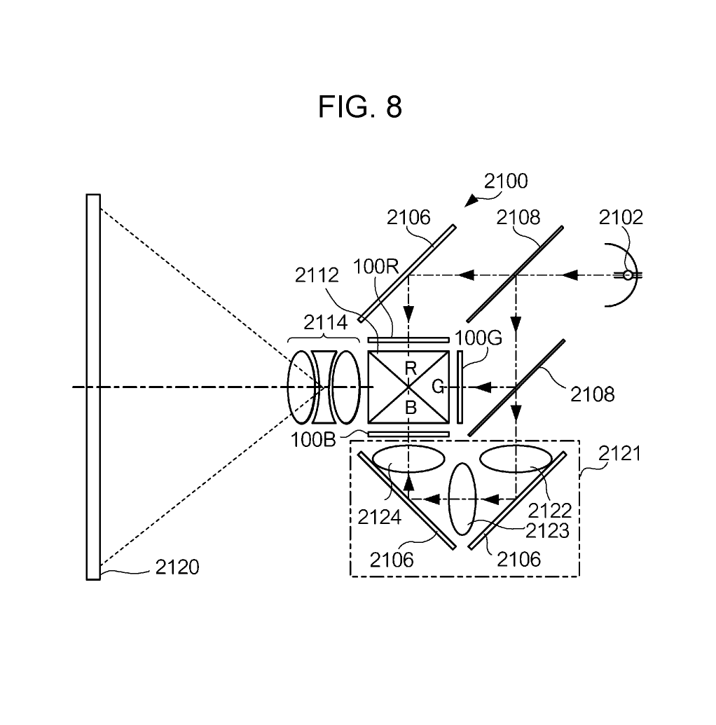

FIG. 8 is a diagram showing a projector 2100 according to one embodiment. The projector 2100 is an example of the electronic apparatus using the electro-optical device 1. In the projector 2100, the electro-optical device 1 is used as a light valve, and high-definition and bright display can be achieved without enlarging the device. As shown in the diagram, a lamp unit 2102 having a white light source, such as a halogen lamp is provided inside the projector 2100. The projected light emitted from the lamp unit 2102 is separated into three primary colors, red (R) color, green (G) color, and blue (B) color by three mirrors 2106 and two dichroic mirrors 2108 provided inside the lamp unit 2102. The separated projection light is guided to light valves 100R, 100G, and 100B corresponding to the respective primary colors. Since the B color light has a long optical path as compared with the other R color and G color, in order to prevent the loss thereof, the light of the B color is guided through a relay lens system 2121 having an incidence lens 2122, a relay lens 2123, and an emission lens 2124.

In the projector 2100, three sets of liquid crystal display devices including the electro-optical device 1 are provided corresponding to R color, G color, and B color, respectively. The configuration of the light valves 100R, 100G and 100B is similar to that of the electro-optical panel 100 described above, and is connected to the upper circuit in the projector 2100 via the first wiring substrate 20 and the second wiring substrate 30. The video signals specifying the gradation level of each of the primary color components of R color, G color, and B color are supplied from the external upper circuit and processed in the upper circuit in the projector 2100, respectively, and the light valves 100R, 100G and 100B are driven, respectively. Light beams modulated by the light valves 100R, 100G, and 100B are incident to a dichroic prism 2112 from three directions, respectively. Then, in the dichroic prism 2112, the R color light and the B color light are refracted by 90 degrees, and the G color light travels straight. Therefore, after the images of each primary color are synthesized, a color image is projected on a screen 2120 by a projection lens group 2114.

Since light beams corresponding to each of the R, G, and B colors are incident to the light valves 100R, 100G, and 100B by the dichroic mirror 2108, it is not necessary to provide a color filter. In addition, the transmission images of the light valves 100R and 100B are projected after being reflected by the dichroic prism 2112, whereas the transmission image of the light valve 100G is projected as it is. Therefore, the horizontal scanning direction by the light valves 100R and 100B is a direction opposite to the horizontal scanning direction by the light valve 100G, and an image in which the left and right thereof are reversed is displayed.

### 4. Modification Example

The aspect of the invention is not limited to the above-described embodiments, and various modifications can be made. Several modification examples will be described below. Two or more of the modification examples below may be used in combination.

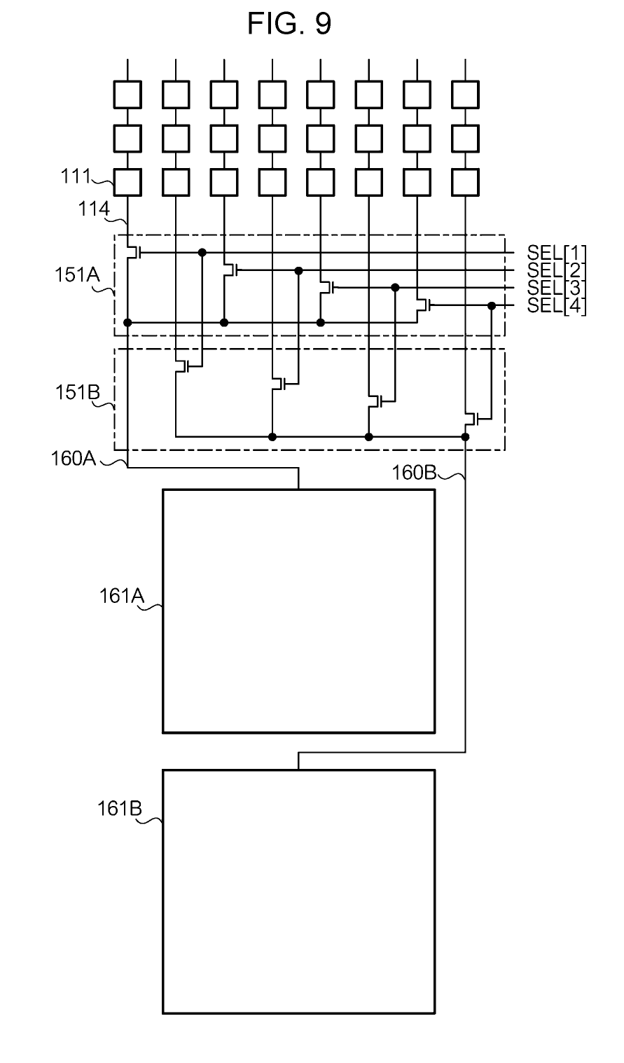

FIG. 9 is a diagram showing another example of the connection relationship between the video signal input terminal 161 and the pixels 111. In the example of FIG. 4, the data line 114 is configured to be connected to the video signal input terminal 161A and the video signal input terminal 161B alternately by k (k=4) pieces. That is, the data lines 114 are connected to a first drive circuit 22 and a second drive circuit 32 alternately by k pieces in units of k pieces of consecutive data lines, and are driven respectively. In the example of FIG. 9, the data lines 114 are alternately connected to the video signal input terminal 161A and the video signal input terminal 161B one by one. That is, the data lines 114 are alternately connected to the first drive circuit 22 and the second drive circuit 32 one by one via the demultiplexer 151 and the video signal line 160 in units of k pieces of non-consecutive data lines, and are driven respectively.

In this example, the first pixel groups are configured to correspond to the data lines 114 in the odd-numbered columns, and the second pixel group is configured to correspond to the data lines 114 in the even-numbered columns. For example, in the case of k=4, the first one of the first pixel groups is configured corresponding to the data lines 114 in the first, the third, the fifth, and the seventh column, and the first one of the second pixel groups is configured to correspond to the data lines 114 in the second, the fourth, the sixth, and the eighth column.

In this example, the data line 114 of the first pixel group connected to the video signal input terminal 161A of the terminal group A and the data line 114 of the second pixel group connected to the video signal input terminal 161B of the terminal group B, are arranged alternately one by one column in the lateral direction (x direction). The demultiplexer 151 selects the data line in one column from the data lines 114 in the k columns for each of the first pixel group and the second pixel group.

In the example of FIG. 9, the demultiplexer 151A corresponding to the first pixel group and the demultiplexer 151B corresponding to the second pixel group overlap. Therefore, in at least portion of the data line selection circuit 150, the wiring layer of the wiring connected to the data line 114 in the odd column and the wiring layer of the wiring connected to the data line 114 in the even column are different. By using a plurality of layers of wirings as described above, even in a case where each non-consecutive data line is divided into k blocks, it is possible to drive the data lines by using a plurality of drive circuits via the terminal groups A and B.

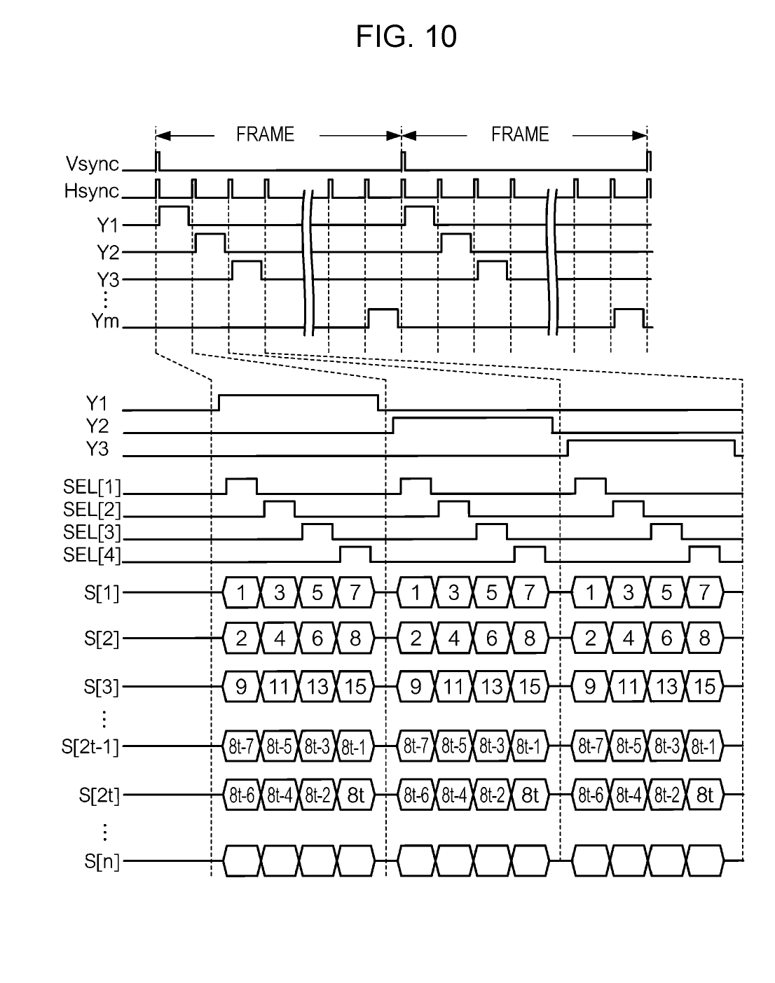

FIG. 10 is a timing chart showing an example of the operation of an electro-optical device 1 according to an example in FIG. 9. For the sake of description, the selection signals SEL[1] to SEL[k] and the video signals S[1] to S[n] at the timing when the scanning signals Y1 to Y3 are at the high level are illustrated. The video signals S[2t−1] and S[2t] are the video signal supplied to the video signal input terminal 161A and the video signal input terminal 161B, respectively. In this example, k=4, and the four data lines 114 are not sequentially arranged. In the video signal S[2t−1], the data written to the pixels 111 of the [8t−7]th, [8t−5]th, [8t−3]th, and [8t−1]th column is time-division multiplexed, and in the video signal S[2t], the data to be written to the pixels 111 of the [8t−6] th, [8t−4] th, [8t−2]th, and [8t] th column is time-division multiplexed.

In this example, the data lines 114 are alternately arranged one by one, one connected to the first drive circuit 22 and one connected to the second drive circuit 32. The first drive circuit 22 supplies the video signal S(2t−1) corresponding to the first pixel group to the video signal input terminal 161A, and the second drive circuit 32 supplies the video signal S(2t) corresponding to the first pixel group to the video signal input terminal 161B. Therefore, it is possible to further suppress display unevenness due to variations in characteristics of the data line drive circuits as compared with the example of FIG. 4. As described above, the first drive circuit 22 and the second drive circuit 32 are provided in different wiring substrates (the first wiring substrate 20 and the second wiring substrate 30) respectively. By arranging the video signal input terminal 161A to which the video signal supplied from the first drive circuit 22 is input and the video signal input terminal 161B to which the video signal supplied from the second drive circuit 32 is input, it is possible to achieve smaller size and higher definition as compared with the case where these are arranged in the lateral direction. In addition, high-speed driving is also facilitated, and display unevenness can be further suppressed.

In the embodiment described above, an example in which two wiring substrates are used for one electro-optical panel is described, but three or more wiring substrates may be used for one electro-optical panel, and the terminal groups may be arranged in three stages.

The electro-optical panel 100 is not limited to a transparent liquid crystal panel. The electro-optical panel 100 may be a reflective type liquid crystal panel. Alternatively, the electro-optical panel 100 may use electro-optical elements other than a liquid crystal, such as a Digital Mirror Device (DMD) and an organic Electroluminescence (EL) element.

The electronic apparatus using the electro-optical panel 100 is not limited to the projector 2100 illustrated in FIG. 8. The electro-optical panel 100 may be applied to an electronic apparatus having a direct view type display device such as a television, an electronic view finder, a car navigation device, a pager, an electronic organizer, an electronic calculator, a word processor, a workstation, a video phone, a POS terminal, a digital still camera, a mobile phone, a smartphone, a tablet type terminal, or the like.

Priority is claimed under 35 U.S.C. §119 to Japanese Application No. 2016-146308 filed on Jul. 26, 2016, which is hereby incorporated by reference in its entirety.

What is claimed is:

1. An electro-optical device comprising:
a substrate on which a pixel area having a first pixel group and a second pixel group is provided;
a first terminal group that is arranged in a peripheral portion of the substrate and in which a first terminal to which a video signal corresponding to the first pixel group is supplied is arranged in a first direction; and
a second terminal group that is arranged in the peripheral portion of the substrate and in which a second terminal to which a video signal corresponding to the second pixel group is supplied is arranged in the first direction,
wherein the length of the pixel area in the first direction is smaller than the combined length of the length of the first terminal group in the first direction and the length of the second terminal group in the first direction.

2. The electro-optical device according to claim 1, further comprising:
selection circuit that selects a pixel to which a video signal is to be respectively supplied from the first pixel group and the second pixel group.

3. The electro-optical device according to claim 1,
wherein the first terminal and the second terminal have the same position in the first direction.

4. The electro-optical device according to claim 1, further comprising:
a first wiring substrate that is connected to the first terminal group; and
a second wiring substrate that is connected to the second terminal group.

5. The electro-optical device according to claim 4,
wherein the first wiring substrate is provided with a first drive circuit that supplies video signals to the first pixel group, and
the second wiring substrate is provided with a second drive circuit that supplies video signals to the second pixel group.

6. The electro-optical device according to claim 4,
wherein the first wiring substrate and the second wiring substrate have the same function and shape.

7. The electro-optical device according to claim 4,
wherein the first wiring substrate and the second wiring substrate are provided on one side of the substrate.

8. The electro-optical device according to claim 4,
wherein the first wiring substrate is provided on a first side of the substrate, and
the second wiring substrate is provided on a second side opposite to the first side.

9. An electro-optical device comprising:
a substrate;
a plurality of pixels that are provided on the substrate and have a first pixel group and a second pixel group arranged in a first direction with respect to the first pixel group;
a first terminal that is formed on the substrate;
a second terminal that is formed on the substrate and arranged in a second direction intersecting the first direction with respect to the first terminal; and
a selection circuit that selects a pixel to which a video signal is to be respectively supplied from the first pixel group and the second pixel group.

10. The electro-optical device according to claim 9,
wherein the arrangement position of the first terminal and the second terminal in the first direction is the same.

11. The electro-optical device according to claim 9,
wherein the first pixel group and the second pixel group are respectively arranged by k columns in the first direction (k is an integer of 2 or more), and
the selection circuit selects a pixel group in one column from the pixel group in the k columns for each of the first pixel group and the second pixel group.

12. The electro-optical device according to claim 9,
wherein the first pixel group and the second pixel group are arranged in a total of k columns by being alternately arranged by one column in the first direction, and
the selection circuit selects a pixel group in one column from the pixel group in the k columns for each of the first pixel group and the second pixel group.

13. The electro-optical device according to claim 12,
wherein the selection circuit includes a first wiring layer having a wiring for supplying video signals to the first pixel group and a second wiring layer having a wiring for supplying video signals to the second pixel group, that is different from the first wiring layer.

14. The electro-optical device according to claim 9, further comprising:
a first wiring substrate that is connected the first terminal; and
a second wiring substrate that is connected to the second terminal.

15. The electro-optical device according to claim 14,
wherein the first wiring substrate is provided with a first drive circuit that supplies video signals to a first pixel group, and
the second wiring substrate is provided with a second drive circuit that supplies video signals to a second pixel group.

16. The electro-optical device according to claim 14,
wherein the first wiring substrate and the second wiring substrate have the same function and shape.

17. The electro-optical device according to claim 14,
wherein the first wiring substrate and the second wiring substrate are provided on one side of the substrate.

18. The electro-optical device according to claim 14,
wherein the first wiring substrate is provided on a first side of the substrate, and
the second wiring substrate is provided on a second side opposite to the first side.

19. An electronic apparatus comprising:
the electro-optical device according to claim 1.

20. An electronic apparatus comprising:
the electro-optical device according to claim 9.
